(19) United States
(12) Patent Application Publication
(10) Pub. No.: US 2011/0309271 A1
(43) Pub. Date: Dec. 22, 2011

(54) SPECTRAL PURITY FILTER AND EXTREME ULTRAVIOLET LIGHT GENERATION APPARATUS PROVIDED WITH THE SPECTRAL PURITY FILTER

(75) Inventors: Masato MORIYA, Oyama (JP); Osamu Wakabayashi, Hiratsuka (JP)

(73) Assignee: GIGAPHOTON INC.

(21) Appl. No.: 13/160,033

(22) Filed: Jun. 14, 2011

(30) Foreign Application Priority Data
Jun. 16, 2010 (JP) 2010-137359
Mar. 29, 2011 (JP) 2011-73368
May 24, 2011 (JP) 2011-116350

(51) Int. Cl. G21K 5/00; F21V 9/06

(52) U.S. Cl. 250/504 R; 359/361

(57) ABSTRACT

A spectral purity filter may include: a plurality of segments that each includes a mesh in which an array of apertures of an aperture size at or below a predetermined size is formed and which has electroconductivity; and a frame that supports the plurality of the segments at least at a periphery thereof.

### CROSS-REFERENCE TO RELATED APPLICATIONS

The present application claims priority from Japanese Patent Application No. 2010-137359 filed Jun. 16, 2010, Japanese Patent Application No. 2011-073368 filed Mar. 29, 2011, and Japanese Patent Application No. 2011-116350 filed May 24, 2011.

### BACKGROUND

1. Technical Field

This disclosure relates to a spectral purity filter

(SPF) and to an extreme ultraviolet (EUV) light generation apparatus provided with the spectral purity filter.

2. Related Art

In recent years, as semiconductor processes become finer, photolithography has been making rapid progress toward finer fabrication. In the next generation, microfabrication at 70 nm to 45 nm, and further, microfabrication at 32 nm and beyond will be required. Accordingly, in order to meet the demand for microfabrication at 32 nm and beyond, for example, an exposure apparatus is expected to be developed, in which an apparatus for generating EUV light at a wavelength of approximately 13 nm is combined with a reduced projection reflective system.

Three types of EUV light generation apparatuses have been known, which include an LPP (Laser Produced Plasma) type apparatus in which plasma generated by irradiating a target material with a laser beam is used, a DPP (Discharge Produced Plasma) type apparatus in which plasma generated by electric discharge is used, and an SR (Synchrotron Radiation) type apparatus in which orbital radiation is used.

### SUMMARY

A spectral purity filter according to one aspect of this disclosure may include: a plurality of segments that each includes a mesh in which an array of apertures of an aperture size at or below a predetermined size is formed and which has electroconductivity; and a frame that supports the plurality of the segments at least at a periphery thereof.

An apparatus according to another aspect of this disclosure may be an apparatus for generating extreme ultraviolet light by irradiating a target material with a laser beam outputted from an external driver laser in which a laser gas containing a carbon dioxide gas is used as a laser medium, whereby the target material is turned into plasma, and the apparatus may include: a chamber in which the extreme ultraviolet light is generated; a target supply unit for supplying the target material to a predetermined position inside the chamber; a collector mirror for collecting and reflecting the extreme ultraviolet light emitted from the plasma; and a spectral purity filter including a plurality of segments that each includes a mesh in which an array of apertures of an aperture size at or below a predetermined size is formed and which has electroconductivity, and a frame that supports the plurality of the segments at least at a periphery thereof, the spectral purity filter being disposed on an optical path of the extreme ultraviolet light reflected by the collector mirror.

### BRIEF DESCRIPTION OF THE DRAWINGS

FIG. 1 schematically illustrates the configuration of an EUV exposure system to which an EUV light generation apparatus according to a first embodiment is applied.

FIG. 2 is a plan view illustrating the configuration of a segmented SPF used in the EUV light generation apparatus shown in FIG. 1.

FIG. 3 is a plan view illustrating a single segment included in the SPF shown in FIG. 2.

FIG. 4 is a fragmentary exploded view of the segment shown in FIG. 3.

FIG. 5 is a sectional view, taken along V-V plane, of the segment shown in FIG. 4.

FIG. 6 is an exploded sectional view illustrating another example of the segment shown in FIGS. 4 and 5.

FIG. 7 is a plan view schematically illustrating the configuration of a segmented SPF according to a second embodiment.

FIG. 8 is a plan view illustrating a single segment included in the SPF shown in FIG. 7.

FIG. 9 is a plan view illustrating the configuration of a segmented SPF according to a third embodiment.

FIG. 10 is a plan view illustrating a single segment included in the SPF shown in FIG. 9.

FIGS. 11A and 11B are sectional views of the segment shown in FIG. 10.

FIG. 12 illustrates the relationship between an angle of incidence of EUV light and transmittance of the EUV light, with the width of a mash being a parameter.

FIG. 13 illustrates an example of the angle of incidence on the SPF in the MTV light generation apparatus shown in FIG. 1.

FIG. 14 schematically illustrates the configuration of an EUV exposure system to which an EUV light generation apparatus according to a fourth embodiment is applied.

FIG. 15 is a plan view illustrating the configuration of a segmented SPF used in the EUV light generation apparatus shown in FIG. 14.

FIG. 16 is a side view of the SPF shown in FIG. 15.

FIG. 17 is a perspective view illustrating a segmented SPF, according to a modification, used in the MTV light generation apparatus shown in FIG. 14.

FIG. 18 is a perspective view of the SPF shown in FIG. 17.

FIG. 19 schematically illustrates the configuration of an EUV exposure system to which an EUV light generation apparatus according to a fifth embodiment is applied.

### DESCRIPTION OF PREFERRED EMBODIMENTS

Hereinafter, selected embodiments of this disclosure will be described in detail, as mere examples, with reference to the drawings. The embodiments described below are merely illustrative of this disclosure, and do not limit the scope of this disclosure. Further, configurations described in connection with the subsequent embodiments may not all be essential in this disclosure. In the description to follow, like elements are referenced by like reference numerals, and the duplicate description thereof will be omitted.

15

### First Embodiment

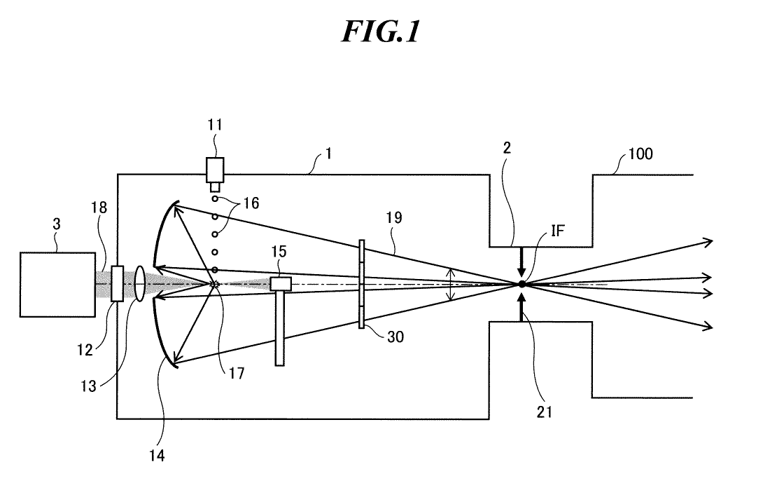

FIG. 1 schematically illustrates the configuration of an EUV exposure system to which an EUV light generation apparatus according to a first embodiment may be applied. An LPP method is employed in this EUV light generation apparatus, in which a target material is irradiated with a driver laser beam and turned into plasma, and EUV light is emitted.

As illustrated in FIG. 1, the EUV light generation apparatus may include an EUV chamber 1 in which the EUV light is generated, a connection 2 where the EUV chamber 1 is connected to an exposure apparatus 100, a driver laser 3 that outputs a driver laser beam, and so forth. One or more vacuum pumps (not shown) may be connected to the EUV chamber 1 and to the connection 2, with which a gas or the like may be discharged from the EUV chamber 1 and the connection 2 . Here, a case where the driver laser 3 is included in the EUV light generation apparatus will be illustrated as an example; however, the driver laser 3 may be configured as a separate laser apparatus from the EUV light generation apparatus for outputting a driver laser beam to the EUV light generation apparatus.

The EUV chamber 1 may be provided with a droplet generator 11, an input window 12, a laser beam focusing optical system 13, an EUV collector mirror 14, a beam dump 15, a segmented spectral purity filter (SPF) 30, and so forth.

The droplet generator 11 may supply a target 16 toward a predetermined region (plasma generation region 17) inside the EUV chamber 1. As a material for the target 16, liquid tin (Sn), liquid lithium (L1), colloidal tin oxide particulates dispersed in water, volatile solvents such as methanol, and so forth, maybe used. As an example, the droplet generator 11 may be configured such that solid tin stored thereinside is heated to be molten and a liquid tin droplet is supplied as the target 16 into the EUV chamber 11.

The driver laser 3 may be a high-power CO₂ pulse laser apparatus in which a laser medium containing carbon dioxide (CO₂) is used. For example, the driver laser 3 may, at an output of 20 kW, output a driver laser beam 18 (CO₂ laser beam) at a wavelength of 10.6 μm, with a pulse repetition rate of 100 kHz, and of a pulse width of 20 ns.

The driver laser beam 18 outputted from the driver laser 3 may be introduced into the EUV chamber 1 via the input window 12. The laser beam focusing optical system 13 may be configured of at least one optical element disposed either inside or outside the EUV chamber 1, and may guide the driver laser beam 18 outputted from the driver laser 3 to the plasma generation region 17 and may focus the driver laser beam 18 therein.

The driver laser beam 18 outputted from the driver laser 3 may strike the target 16 via the input window 12 and the laser beam focusing optical system 13, whereby the target 16 may be turned into plasma. This plasma may emit rays of light at various wavelengths including EUV light 19. The MN light 19 may be collected by the EUV collector mirror 14, which reflects light at a predetermined wavelength (for example, 13.5 nm) with high reflectance, and be outputted to an external apparatus (for example, exposure apparatus 100) in which the EUV light 19 is used.

The EUV collector mirror 14 may have a spheroidal, multi-layered reflective surface laminated alternately with thin layers of molybdenum (Mo) and silicon (Si). The EUV light 19 emitted from the plasma may be reflected by the EUV collector mirror 14 and be focused at an intermediate focus IF.

A wall 21 provided with a pin-hole therein may be disposed in the connection 2. The pin-hole may be around a few millimeters in diameter. The EUV collector mirror 14 may preferably be disposed such that the intermediate focus IF substantially coincides with the position of the pin-hole in the wall 21. With this configuration, the EUV light having passed through the pin-hole in the wall 21 may be guided to an external apparatus, such as the exposure apparatus 100.

In embodiments described hereinafter, a segmented SPF may be provided on an optical path in the EUV light generation apparatus (EUV chamber 1 or connection 2) or in the exposure apparatus 100. The segmented SPF may preferably be configured to reflect at least the driver laser beam 18 with high reflectance and to transmit, with high transmittance, the EUV light 19 at the central wavelength of 13.5 nm required for the EUV photolithography.

As illustrated in FIG. 1, for example, disposing the segmented SPF 30 on the optical path of the EUV light 19 and between the plasma generation region 17 and the intermediate focus IF may allow the EUV light 19 to be transmitted through the segmented SPF 30 while at least the driver laser beam 18 may be prevented from being transmitted therethrough.

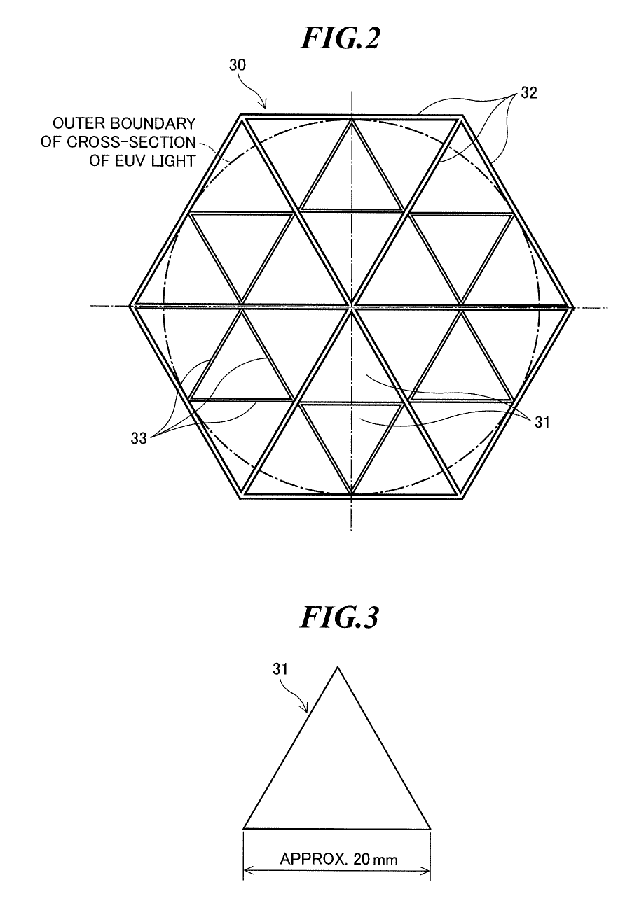

FIG. 2 is a plan view illustrating the configuration of the segmented SPF used in the EUV light generation apparatus shown in FIG. 1. In FIG. 2, the outer boundary of a cross-section of the EUV light is shown with a dash-dotted line. The SPF 30 may preferably have the effective diameter that may cover the cross-section of the EUV light at the position where the SPF 30 is disposed. As illustrated in FIG. 2, the SPF 30 may include a plurality of segments 31 and frames (main frame 32 and sub-frame 33) for supporting the segments 31.

The main frame 32 may constitute a frame for a group of segments (four segments forming an equilateral triangle in FIG. 2). The sub-frame 33 may support individual segments 31 in the frame constituted by the main frame 32. In the first embodiment, the main frames 32 and the sub-frames 33 may be disposed on substantially the same plane so that the segments 31 are all disposed on substantially the same plane.

Each segment 31 may be a polygonal plate-like member (for example, equilateral triangle, isosceles triangle, square, rectangle, trapezoid, hexagon, and so forth), and the plurality of the segments 31 maybe disposed tightly without a space therebetween. Employing such segmented SPF 30 may make it possible to increase an SPF in size and to improve the mechanical strength of the SPF. In the first embodiment, a case where each segment 31 is equilateral triangular in shape will be illustrated as an example.

FIG. 3 is a plan view illustrating one of the segments 31 included in the SPF 30 shown in FIG. 2. Each segment 31 may be equilateral triangular in shape with the side length of approximately 20 mm, for example, and may be constituted of a wafer or the like on which fine patterns are formed by microfabrication process. For example, the fine patterns may be formed on a single-crystal silicon wafer of six inches in diameter and 560 μn in thickness by the photolithography technique, and subsequently the silicon wafer may be processed into equilateral triangular chips, each with the side length of approximately 20 mm, whereby the segments 31 may be manufactured.

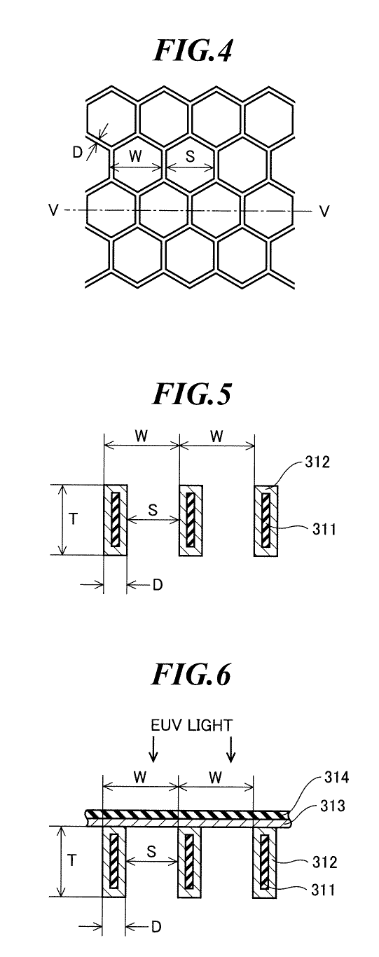

FIG. 4 is a fragmentary exploded view of the segment shown in FIG. 3, and FIG. 5 is a section, taken along V-V plane, illustrating the segment shown in FIG. 4 in enlargement. Each segment 31 may be manufactured by forming arrays of regular hexagonal apertures on a silicon wafer by etching, the aperture not being larger in size than a predetermined aperture size. Each segment 31 manufactured in this way may have a honeycomb mesh structure in which the arrays of apertures not larger in size than the predetermined aperture size are formed. Hereinafter, a case where each aperture is regular hexagonal will be illustrated as an example; however, each aperture (mesh) may be polygonal (for example, equilateral triangle, isosceles triangle, square, rectangle, trapezoid, and so forth) , or may be in a shape defined by a curved line, such as a circle, an ellipse, or the like.

Here, an aperture size S may be set at or below half the length of the wavelength of an electromagnetic wave (CO2 laser beam in this embodiment) to be reflected. For example, setting the aperture size S at or below 5 μm may yield the transmittance of the CO₂ laser beam, at the wavelength of 10.6 μm, of approximately one-thousandth, whereby the CO₂ laser beam transmitted through the SPF 30 maybe reduced. Meanwhile, in the above case, the EUV light, at the central wavelength of 13.5 nm, may be transmitted through the SPF 30 in accordance with the aperture ratio of the mesh.

In the first embodiment, a case where the aperture size S is 3.9 μm, a width D of the mesh (frame) is at or below 0.4 μm, a pitch W of the mesh is 4.3 μm, and a thickness T of the mesh is 5 μm will be illustrated as an example. Setting a value of the thickness T of the mesh at substantially the same as a value of the pitch W (sum of the aperture size S and the width D of the mesh) of the mesh may make it possible to improve the mechanical strength of the mesh. Further, the honeycomb structure, obtained by tightly arranging regular hexagons, is strong and is less likely to deform; thus, the frame defining each regular hexagon may be thin. Accordingly, a high aperture ratio (high EUV light transmittance) can be achieved, advantageously, while the mechanical strength of the mesh is maintained.

The mesh may preferably have electroconductivity so that the electromagnetic wave may be reflected thereby. Accordingly, each segment may preferably be configured of an electroconductive material. Alternatively, if each segment is configured of an electrically insulating material, such as a silicon wafer, the mesh may preferably be coated with metal, such as gold (Au), molybdenum (Mo), or the like, so that electroconductivity thereof may be enhanced. In this case, the metal may preferably be coated at least on a surface of the mesh on which the electromagnetic wave is incident.

In FIG. 5, a metal coating 312 is provided on side surfaces and on the surface, from which the electromagnetic wave is outputted, of single-crystal silicon 311 constituting the mesh. The metal coating 312 may enhance the reflectance of the CO₂ laser beam by the mesh, and at the same time, may reduce the absorption of the CO₂ laser beam by the SPF 30, whereby thermal deformation of and damage to the SPF 30 may be suppressed. Further, configuring the mesh of a material with high thermal conductivity may make it possible to remove heat therefrom efficiently via the frames supporting the periphery of the segment, whereby thermal deformation of and damage to the SPF 30 may be suppressed.

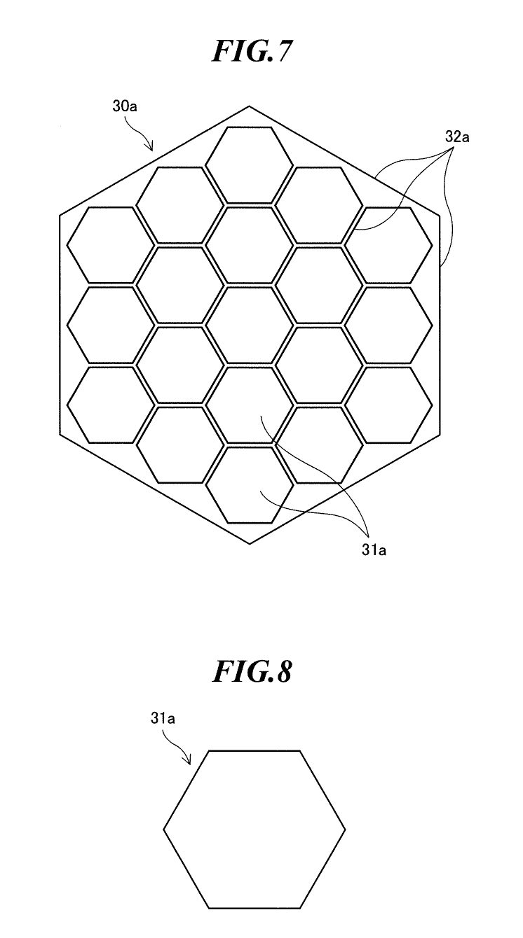

As another example of the segment shown in FIGS. 4 and 5, as illustrated in FIG. 6, a multi-layered thin film may be formed on the principal surface of the mesh. In FIG. 6, a zirconium thin film 313 and a silicon thin film 314 may be formed at the side of a surface of the single-crystal silicon 311 on which the electromagnetic wave is incident, with the metal coating being provided between the zirconium thin film 313 and the silicon thin film 314. Materials such as zirconium (Zr), silicon (Si), and the like, have higher reflectance to the EUV light at the wavelength of 13.5 nm, compared to the reflectance to light at other wavelengths.

Accordingly, forming these thin films on the mesh may allow the SPF 30 shown in FIG. 1 to function as a thin film filter as well, and removal efficiency of EUV light at wavelengths other than 13.5 nm, VUV light, DW light, ultraviolet light, visible light, infrared light, and so forth may be improved. Further, disposing the thin film filter between the EUV chamber 1 and the exposure apparatus 100 may prevent the target material introduced into the EUV chamber 1 or debris scattered from the target material from flowing into the exposure apparatus 100, whereby optical elements inside the exposure apparatus 100 can be protected against damage thereto.

Referring again to FIG. 2, a material that has high thermal conductivity and a small thermal expansion coefficient, such as silicon carbide (SiC), aluminum nitride (A1N), or the like, may preferably be used as the material for the frames (main frame 32 and sub-frame 33). Further, the surface of each frame may preferably be coated with metal, such as molybdenum (Mo) or the like, that has high reflectance to the CO₂ laser beam.

The frame may be configured to support the segment 31 at least at the periphery thereof. The segment 31 may be fixed to the frame with, for example, brazing, adhesive bonding, soldering, and so forth, at least at the periphery thereof. Alternatively, nano-metal ink may be used to bond the segment 31 to the frame. The nano-metal ink may be ink in which nanoparticles of silver (Ag) or the like, for example, are dispersed in a solvent. The nano-metal ink may be applied between the inner circumference of the frame and the outer periphery of the segment 31, with the segment 31 being mounted onto the frame. Further, the frame and the segment 31 with the nano-metal ink being applied therebetween may be heated to approximately 400 ° C. in order to volatilize the solvent, whereby the segment 31 may be bonded to the frame.

Preferred metal substances for constituting the nanoparticles of the nano-metal ink may include, aside from silver mentioned above, gold, copper, platinum, palladium, rhodium, ruthenium, iridium, osmium, nickel, bismuth, and so forth. Solvents in which ultrafine metal particles may be dispersed may include liquid containing water and/or an organic solvent That is, the solvent may be water, a mixture of water and an organic solvent, or an organic solvent. The organic solvent may be methanol, ethanol, 1-propanol, 2-propanol, t-butyl alcohol, or the like.

### Second Embodiment

FIG. 7 is a plan view illustrating the configuration of a segmented SPF according to a second embodiment. In the second embodiment, an SPF 30a in which each segment 31a is hexagonally shaped may be used.

As illustrated in FIG. 7, the SPF 30a may include a plurality of the segments 31a and frames 32a for supporting the segments 31a. In the second embodiment, the frames 32a may substantially planar and be disposed on substantially the same plane so that the segments 31a are all disposed on substantially the same plane. The segment 31a may be a plate-like member of a regular hexagonal shape, and the plurality of the segments 31a may be disposed tightly without a space therebetween. Using such segmented SPF 30a may allow the SPF to be increased in size and also the mechanical strength thereof to be increased.

FIG. 8 is a plan view illustrating one of the segments 31a included in the SPF 30a shown in FIG. 7. The segment 31a maybe constituted of a wafer or the like on which fine patterns are formed by microfabrication process. For example, the fine patterns may be formed on a single-crystal silicon wafer by photolithography technique, and subsequently the silicon wafer may be processed into regular hexagonal chips, whereby the segments 31a may be manufactured. Further, as in the first embodiment, the mesh may be coated with metal, such as gold (Au), molybdenum (Mo), and so forth.

According to the second embodiment, compared to the case where the triangular segments are used, using the hexagonal segments 31a having a relatively large vertex angle of 120° may reduce the possibility of the segments 31a being damaged at the vertices thereof.

### Third Embodiment

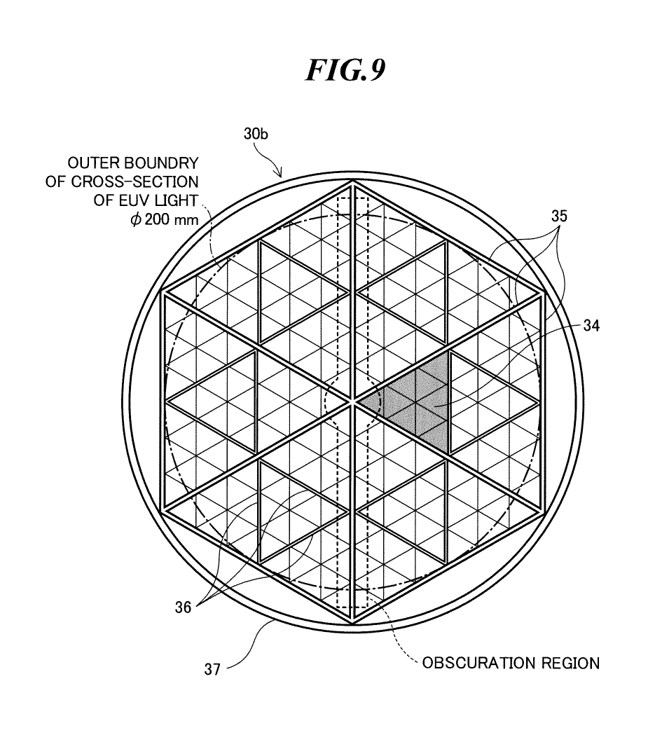

FIG. 9 is a plan view illustrating the configuration of a segmented SPF according to a third embodiment. In FIG. 9, the outer boundary of a cross-section of the EUV light is shown with a dash-dotted line. An SPF 30b may preferably have the effective diameter that may cover the cross-section of the EUV light at the position where the SPF 30b is disposed. In the third embodiment, the cross-section of the EUV light at the position where the SPF 30b is disposed may be approximately 200 mm in diameter, and the SPF 30b having an effective diameter of approximately 200 mm can be configured by disposing twenty-four equilateral triangular segments 34, each with the side length of approximately 60 mm, on substantially the same plane.

As illustrated in FIG. 9, the SPF 30b may include twenty-four segments 34, frames (main frame 35 and sub-frame 36) for supporting the segments 34, and a circular frame 37 for supporting the frame 35 and for anchoring the SPF 30b to an EUV light generation apparatus or the like.

The main frame 35 may constitute a frame for a group of segments (four segments configuring an equilateral triangle in FIG. 9). The sub-frame 36 may support individual segments 34 within the frame constituted by the main frame 35. In the third embodiment, since the segment 34 is relatively large, each segment 34a may be provided with a reinforcement unit, which will be described later. In the third embodiment as well, the main frames 35, the sub-frames 36, and the circular frame 37 may be substantially planar and be disposed on substantially the same plane so that the segments 34 may all be disposed on substantially the same plane.

A material that has high thermal conductivity and a small thermal expansion coefficient, such as silicon carbide (SiC), aluminum nitride (AlN), or the like, may preferably be used as a material for the main frame 35, the sub-frame 36, and the circular frame 37. Further, the surface of the frames may preferably be coated with metal, such as molybdenum (Mo) or the like, that has high reflectance to the CO₂ laser beam.

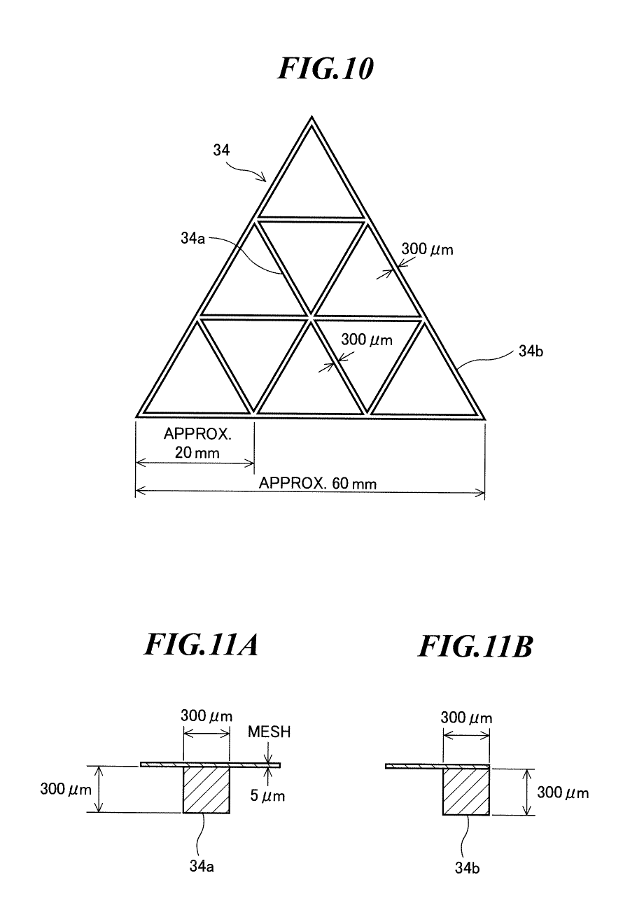

FIG. 10 is a plan view illustrating one of the segments included in the SPF 30b shown in FIG. 9. The segment 34 may be equilateral triangular in shape with the side length of approximately 60 mm, and may be constituted of a wafer or the like on which fine patterns are formed by microfabrication process. For example, the fine patterns may be formed on a single-crystal silicon wafer by photolithography technique, and subsequently the silicon wafer may be processed into equilateral triangular chips each with the side length of approximately 60 mm, whereby the segments 34 may be manufactured. Further, in order to reinforce the segment 34, reinforcement units 34a and 34b may be provided on part of the mesh. The reinforcement units 34a and 34b maybe configured as equilateral triangular frames each with the side length of approximately 20 mm, for example.

FIGS. 11A and 11B are sectional views of the segment shown in FIG. 10. FIG. 11A illustrates the reinforcement unit 34a provided at the center portion of the segment 34, and FIG. 11B illustrates the reinforcement unit 34b provided at the periphery of the segment 34. In the example shown in FIGS. 10, 11A, and 11B, the reinforcement is approximately 300 μm in width and approximately 300 μm in thickness, and the mesh of the segment is approximately 5 μm in thickness.

The reinforcement units 34a and 34b may, for example, be fixed to the frames with brazing, adhesive bonding, soldering, nano-metal ink, and so forth. The reinforcement unit 34b may be fixed at least to either of the main frame 35 or the sub-frame 36 shown in FIG. 9. In this way, providing the reinforcement units 34a and 34b may make it possible to enhance the strength of the SPF 30b. Further, as in the example shown in FIG. 6, a multi-layered thin film may be formed on the principal surface of the mesh.

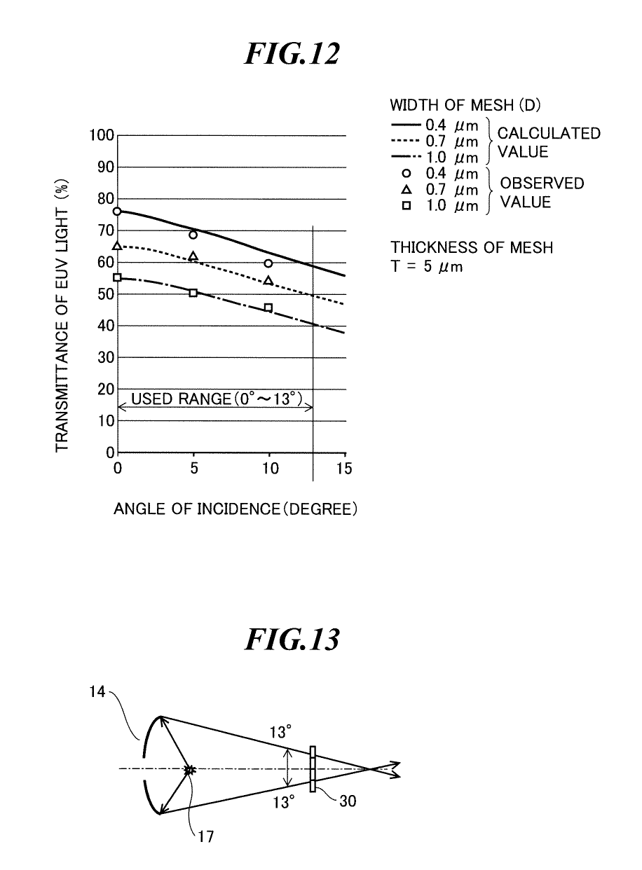

FIG. 12 shows the relationship between the angle of incidence and the transmittance of the EMT light, with the width of the mesh being a parameter. Shown in FIG. 12 is the relationship between the angle of incidence (degree) of the EUV light on the SPF 30 and the transmittance (%) of the EUV light through the SPF 30 (calculated values and observed values), in a case where the width D of the mesh in the SPF 30 shown in FIGS. 2 through 5 is varied to 0.4 μm, 0.7 μm, and 1.0 μm.

FIG. 13 shows an example of the angle of incidence of the EUV light on the SPF 30 in the EUV light generation apparatus shown in FIG. 1. In this example, the angle of incidence of the MTV light generated in the plasma generation region 17 and reflected by the EUV collector mirror 14 so as to be incident on the SPF 30 may vary from 0 degree to 13 degrees.

Referring again to FIG. 12, it is contemplated that the narrower the width D of the mesh, the higher the transmittance of the EUV light. The transmittance of the EUV light may be at the highest when the angle of incidence of the EUV light is 0 degree, and may decrease by approximately 15% when the angle of incidence of the EUV light is increased to 13 degrees. This may be due to the blind effect by the thickness T of the mesh. Thus, it is contemplated that disposing the plurality of the segments such that the angle of incidence of the EUV light on each segment is small may make it possible to increase the transmittance of the EUV light.

10

### Fourth Embodiment

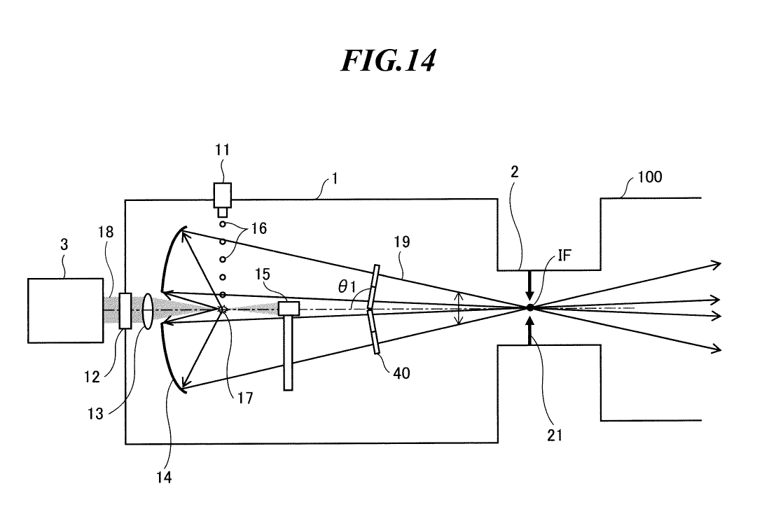

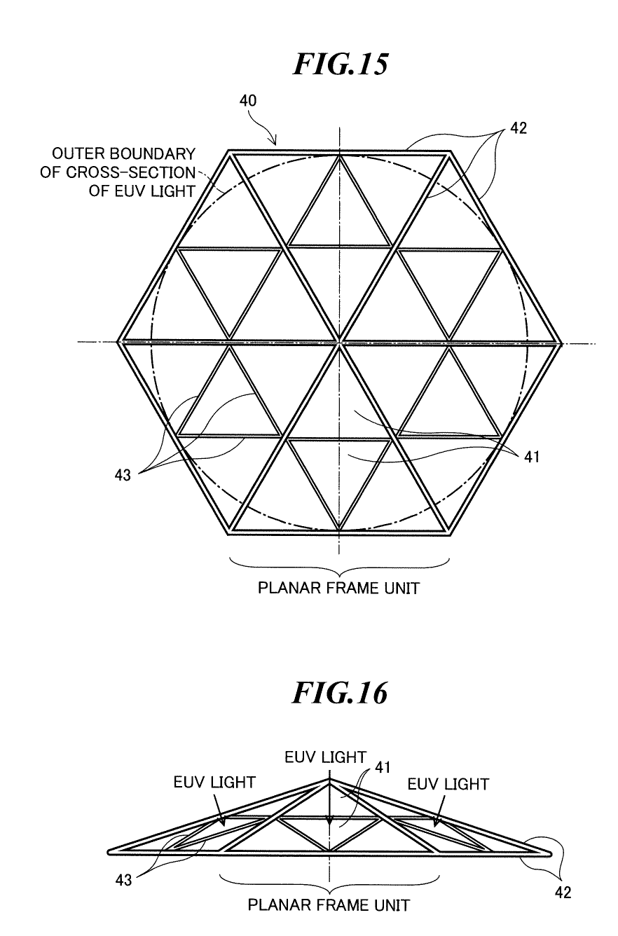

FIG. 14 schematically illustrates the configuration of an EUV exposure system to which an EUV light generation apparatus according to a fourth embodiment is applied. FIG. 15 is a plan view illustrating the configuration of a segmented SPF used in the EUV light generation apparatus shown in FIG. 14, and FIG. 16 is a side view of the SPF shown in FIG. 15. In the fourth embodiment, in place of the planar SPF 30 according to the first embodiment shown in FIG. 1, a three-dimensional SPF 40 may be used.

In the SPF 40, a plurality of segments 41 may preferably disposed on the frame so as to be inclined at a predetermined angle with respect to a plane orthogonal to the central axis of the SPF 40 so that the angle of incidence of the EUV light being reflected by the EUV collector mirror 14 and being incident on the segments 41 comes closer to 0 degree. That is, the frames may support the plurality of the segments 41 such that the surfaces of the plurality of the segments 41 on which the light is incident forms an angle 81, which is greater than 90°, with the central axis of the SPF 40. Here, the central axis of the SPF 40 refers to an axis passing through the center of the SPF in a direction orthogonal to a plane containing the outer periphery of the SPF 40, and in FIG. 14, the central axis may correspond to a line connecting the plasma generation region 17 and the IF.

With this, the angle of incidence of the EUV light 19 that has been reflected by the EUV collector mirror 14 and is incident on the plurality of the segments 41 may become smaller, on average, than the angle of incidence of the EUV light in the case where the EUV light is incident on the plurality of the segments disposed such that the surfaces thereof on which the light is incident are substantially on the same plane. For example, in the configuration shown in FIG. 13, the angle of incidence of the EUV light that has been reflected by the EUV collector mirror 14 and is incident on the plurality of the segments 31 varies from 0 degree to 13 degrees; however, in the configuration shown in FIG. 14, the angle of incidence of the EUV light that has been reflected by the collector mirror 14 and is incident on the plurality of the segments 41 of the SPF 40 varies, for example, from approximately 0 degree to approximately 6 degrees. In this way, disposing the plurality of the segments 41 at an appropriate angle with respect to the central axis of the

SPF 40 may allow the transmittance of the EUV light 19 through the SPF 40 to be improved.

In FIG. 15, the outer boundary of the cross-section of the EUV light is shown with a dash-dotted line. The SPF 40 may preferably have the effective diameter that may cover the cross-section of the EUV light at the position where the SPF 40 is disposed. As illustrated in FIG. 15, the SPF 40 may include the plurality of the segments 41 disposed three-dimensionally, and frames (main frame 42 and sub-frame 43) for supporting the segments 41. The segments 41 may be configured similarly to the segments described in any of the first through third embodiments.

As illustrated in FIGS. 15 and 16, the main frame 42 may constitute a frame for a group of segments (four segments forming an isosceles triangle on the sameplane in this example). The sub-frame 43 may support individual segments 41 within the frame constituted by the main frame 42. In the fourth embodiment, the main frames 42 and the sub-frames 43 may be disposed three-dimensionally so that at least one group of segments are disposed on a plane inclined with respect to a plane on which another group of segments are disposed.

In the fourth embodiment, each segment 41 may be isosceles triangular in shape. The main frame 42 and the sub-frames 43 may be configured such that four segments 41 are disposed on the same plane so as to configure a single isosceles triangle. Six isosceles triangles, each being configured of four segments 41, may be disposed respectively in six planar frames being inclined with respect to one another, to thereby form a six-sided pyramid as a whole.

In this way, the main frames 42 and the sub-frames 43 may support the plurality of the segments 41 such that the surface of each segment 41 on which the light is incident is substantially orthogonal to the direction in which the EW light 19 reflected by the EUV collector mirror 14 travels. Such a configuration may allow the EUV light 19 reflected by the EUV collector mirror 14 to be incident on each segment 41 at an angle close to 0 degree. As a result, compared to the case where all the segments are disposed on the same plane, the transmittance of the EUV light through each segment may be improved.

### Modifications

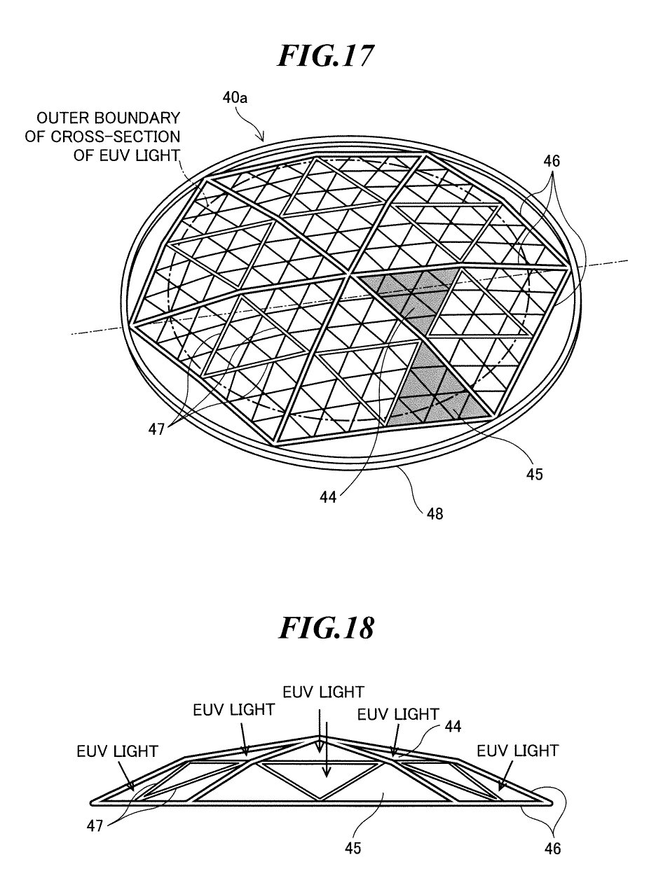

FIG. 17 is a perspective view of a segmented SPF according to a modification, which may be used in the EUV light generation apparatus shown in FIG. 14. In FIG. 17, the outer boundary of a cross-section of the EUV light is shown with a dash-dotted line. An SPF 40a may preferably have the effective diameter that may cover the cross-section of the EUV light at the position where the SPF 40a is disposed.

As illustrated in FIG. 17, the SPF 40a may include two types of segments (first segment 44 and second segment 45), frames (main frame 46 and sub-frame 47) for supporting the first and second segments 44 and 45, and a circular frame 48 for supporting the main frame 47 and anchoring the SPF 40a to the EUV light generation apparatus. The first and second segments 44 and 45 may be configured similarly to the segments described in any of the first through fourth embodiments.

In the modification, the first and second segments 44 and 45 may both be isosceles triangular in shape, but the first and second segments 44 and 45 may differ in shape from each other. In the modification, the first and second segments 44 and 45 may both be relatively large; thus, reinforcement units described with reference to FIGS. 10, 11A, and 11B may be provided respectively to the first and second segments 44 and 45.

FIG. 18 is a side view of the SPF illustrated in FIG. 17. As shown in FIGS. 17 and 18, the main frame 46 may have a shape of a bent isosceles triangle and may constitute a frame for four segments. The sub-frame 47 may support individual segments within the frame constituted by the main frame 46.

In the modification, the main frames 46 and the sub-frames 47 may support the first and second segments 44 and 45 such that the surfaces, on which the light is incident, of the six first segments 44 disposed toward the center of the SPF 40a and the surfaces, on which the light is incident, of the eighteen second segments 45 disposed toward the periphery of the SPF 40a have angles that differ from each other with respect to the central axis of the SPF 40a.

As shown in FIG. 18, the angle of the surface, on which the light is incident, of the second segment 45 with respect to the central axis of the SPF 40a is greater than the angle of the surface, on which the light is incident, of the first segment 44 with respect to the central axis of the SPF 40a, which allows the EUV light 19 reflected by the EUV collector mirror 14 to be incident on the first and second segments 44 and 45 respectively at an angle close to 0 degree. As a result, compared to the configuration according to the fourth embodiment shown in FIGS. 15 and 16, the transmittance of the EUV light 19 through each segment may be improved.

### Fifth Embodiment

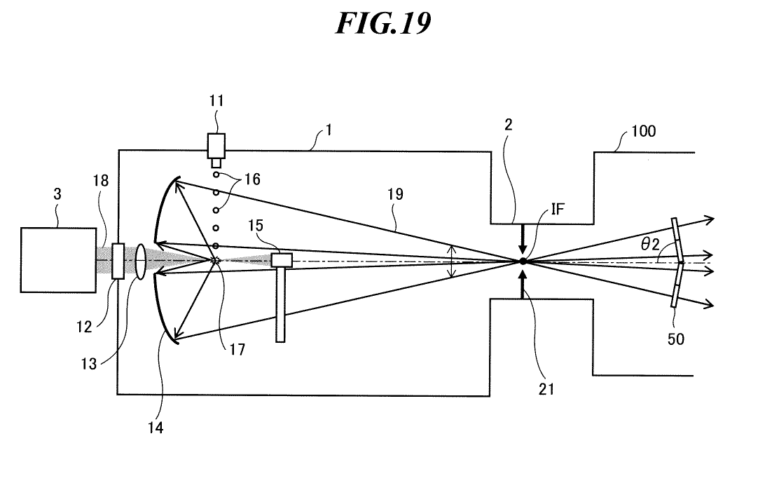

FIG. 19 schematically illustrates the configuration of an EUV exposure system to which an EUV light generation apparatus according to a fifth embodiment may be applied. In the fifth embodiment, in place of the SPF 30 and the SPF 40 disposed in the EUV chamber shown in FIGS. 1 and 14, respectively, an SPF 50 disposed inside the exposure apparatus may be used.

In the fifth embodiment, a three-dimensional SPF 50 may be used, and the shape thereof may differ from that of the SPF 40 according to the fourth embodiment. That is, the frames may support the plurality of the segments such that the surfaces of the plurality of the segments on which the light is incident may form an angle 82, which is smaller than 90° , with the central axis of the SPF 50, so that the angle of incidence of the EUV light 19 that has been reflected by the EUV collector mirror 14 and is incident on each segment via the intermediate focus IF may come close to 0 degree.

With this, it is contemplated that the angle of incidence of the EUV light that has been reflected by the EUV collector mirror 14 and is incident on the plurality of the segments via the intermediate focus IF may be smaller, on average, than the angle of incident of the EUV light in the case where the EUV light is incident on the surfaces of the plurality of the segments disposed on the same plane.

For example, in the configuration shown in FIG. 13, the angle of incidence of the EUV light 19 that has been reflected by the EUV collector mirror 14 and is incident on the plurality of the segments 31 of the SPF 30 may vary from 0 degree to 13 degrees; however, in the configuration shown in FIG. 19, the angle of incidence of the EUV light 19 that has been reflected by the EUV collector mirror 14 and is incident on the plurality of the segments of the SPF 50 via the intermediate focus IF may vary, for example, from 0 degree to approximately 6 degrees. In this way, disposing the plurality of the segments at appropriate angles respectively with respect to the central axis of the SPF 50 may allow the transmittance of the EUV light 19 through each segment to be improved.

In the above-described embodiments, cases where the spectral purity filters are used in the EUV light generation apparatuses have been illustrated as examples; however, the spectral purity filters according to the embodiments of this disclosure are not limited thereto and can be used to improve the spectral purity of laser beams used in systems such as a laser beam machine.

The above descriptions are merely illustrative and not limiting. Accordingly, it is apparent to those skilled in the art that modifications can be made to the embodiments of this disclosure without departing from the scope of this disclosure.

The terms used in this specification and the appended claims should be interpreted as “non-limiting. ” For example, the terms “include” and “be included” should be interpreted as “not limited to the stated elements.” The term “have” should be interpreted as “not limited to the stated elements. ” Further, the modifier “one (a/an)” should be interpreted as “at least one” or “one or more.”

What is claimed is:

1. A spectral purity filter, comprising:
a plurality of segments that each includes a mesh in which an array of apertures of an aperture size at or below a predetermined size is formed and which has electroconductivity; and
a frame that supports the plurality of the segments at least at a periphery thereof.

2. The spectral purity filter according to claim 1, wherein each of the plurality of the segments has a shape of a plate-like polygon.

3. The spectral purity filter according to claim 1, wherein at least the periphery of the plurality of the segments is bonded to the frame with nano-metal ink.

4. The spectral purity filter according to claim 1, wherein
the mesh includes an array of apertures of an aperture size at or below half a wavelength of a laser beam outputted from a driver laser, and
the mesh purifies a spectrum of extreme ultraviolet light generated as a target material is irradiated with the laser beam outputted from the driver laser.

5. The spectral purity filter of claim 1, wherein the mesh includes an array of apertures of an aperture size at or below approximately 5 pm.

6. The spectral purity filter of claim 1, wherein the mesh is coated with a material having electroconductivity on at least a surface thereof on which light is incident.

7. The spectral purity filter of claim 1, wherein the mesh includes an array of apertures that are regular hexagonal in shape.

8. The spectral purity filter of claim 1, wherein the mesh includes a multi-layered thin film formed on a principal thereof.

9. The spectral purity filter of claim 1, wherein the plurality of the segments includes a reinforcement formed on part of the mesh.

10. The spectral purity filter of claim 1 wherein the frame supports the plurality of the segments such that a surface thereof on which light is incident is inclined with respect to a central axis of the spectral purity filter.

11. The spectral purity filter of claim 10, wherein
the plurality of the segments includes first and second groups of segments, and
the frame supports the segments such that the surfaces of the first and second groups of the segments are inclined at different angles respectively with respect to the central axis of the spectral purity filter.

12. An apparatus for generating extreme ultraviolet light by irradiating a target material with a laser beam outputted from an external driver laser in which a laser gas containing a carbon dioxide gas is used as a laser medium, whereby the target material is turned into plasma, the apparatus comprising:
a chamber in which the extreme ultraviolet light is generated;
a target supply unit for supplying the target material to a predetermined position inside the chamber;
a collector mirror for collecting and reflecting the extreme ultraviolet light emitted from the plasma; and
a spectral purity filter including a plurality of segments that each includes a mesh in which an array of apertures of an aperture size at or below a predetermined size is formed and which has electroconductivity, and a frame that supports the plurality of the segments at least at a periphery thereof, the spectral purity filter being disposed on an optical path of the extreme ultraviolet light reflected by the collector mirror.

13. The apparatus according to claim 12, wherein
the frame supports the plurality of the segment such that a surface thereof on which light is incident is inclined with respect to a central axis of the spectral purity filter, and
an angle of incidence of the extreme ultraviolet light being reflected by the collector mirror and being incident on the plurality of the segments is smaller, on average, than an angle of incidence of the extreme ultraviolet light in a case where the plurality of the segments are disposed on the same plane.

14. The apparatus according to claim 13, wherein
the plurality of the segments includes first and second groups of segments, and
the frame supports the segments such that the surfaces of the first and second groups of the segments are inclined at different angles respectively with respect to the central axis of the spectral purity filter.
